(19) United States
(12) Patent Application Publication
(10) Pub. No.: US 2010/0175787 A1
(43) Pub. Date: Jul. 15, 2010

(54) Machine for Machining Workpieces Made from Wood, Plastic and Similar and Tool for Application in Such a Machine

(75) Inventors: Albrecht Dawidziak, Grossrinderfeld (DE); Bernd Martin, Tauberbischofsheim (DE)

Correspondence Address: GUDRUN E. HUCKETT DRAUDT, SCHUBERTSTR. 15A, WUPPERTAL, 42289, DE

(73) Assignee: Michael Weinig AG, Tauberbischofsheim (DE)

(21) Appl. No.: 12/294,945

(22) PCT Filed: Mar. 17, 2007
(86) PCT No.: PCT/EP2007/002380

§ 371 Date: Oct. 1, 2008

(30) Foreign Application Priority Data
Mar. 29, 2006 (DE) 10 2006 015 692.7

(51) Int. Cl. B27C 1/00; B27C 9/02

(52) U.S. Cl. 144/1.1; 144/118; 144/129

(57) ABSTRACT

A machine for machining workpieces of wood and plastics has a rotatably driven spindle and at least one tool that is seated on the rotatably driven spindle and has a circular arrangement of knives. The tool has a tool body and the circular arrangement of knives is supported on the tool body. An inner table acting as a workpiece support is provided, wherein the circular arrangement of knives surrounds the inner table and wherein the inner table is a component of the tool. A machine table is provided on which the workpieces are fed to the at least one tool.

The invention concerns a machine for machining workpieces of wood, plastics and the like according to the preamble of claim 1 and further a tool for use in such a machine according to the preamble of claim 8.

Machines are known in which the tools are configured as side-and-face cutters with which the workpieces when passing through the machine are machined by material removal. In comparison to peripheral milling, the side-and-face cutters have the advantage that the groove patterns can be avoided that are caused by peripheral milling on the machined workpiece surface. Moreover, because the main cutting direction of the side-and-face cutting action is turned by about 90 degrees in comparison to peripheral cutting, fewer tears about the knot areas of the workpieces occur. The side-and-face cutter must have a relatively great diameter that is greater than a maximum workpiece width to be machined. If this is not the case, several tools must be used for machining the same workpiece face and must be aligned very precisely relative to one another so that no steps or traces will be impressed onto the workpiece surface.

In order to achieve excellent machining quality without so-called impaction on the workpiece surface, the workpiece must be supported also in the inner area of the tool. For this purpose, the tool is provided only on its periphery with a circular arrangement of knives and is provided centrally with a recess in which an inner table as a workpiece support is provided. In known machines and tools the inner table is inserted from above and from the outside into the tool. In this connection, the inner table is a fixed non-detachable component of the machine table (DE 1 081 653). However, machines and tools are known in which the inner table is designed to be detachably connected by means of a strip or two strips (EP 0 318 877).

Other solutions operate with a hollow spindle that in turn is supported on a stationary shaft or in which a stationary shaft is supported. On such an optionally height-adjustable shaft, the inner table is arranged (EP 0 904 903; DE 39 09 919; DE 530 842). All of these solutions are constructively complex.

The invention has the object to provide a machine of the aforementioned kind and a tool of the aforementioned kind in such a way that in a constructively simple way an optimal support of the workpiece in the interior area of the tool is achieved.

This object is solved for the machine of the aforementioned kind in accordance with the invention with the characterizing features of claim 1 and for the tool of the aforementioned kind in accordance with the invention with the characterizing portion of claim 8.

In the machine according to the invention and in the tool according to the invention, the inner table is a component of the tool. In this way, a very simple constructive configuration of the machine and the tool results. The inner table can be arranged without problems in the tool and secured thereat.

In the solution according to claim 6, the machine is provided with a jointing device for the cutting edges of the tool. By means of the jointing device it is ensured that the minor cutting edges of the tool that are decisive for the surface of the workpiece have a uniform cutting plane.

Further features of the invention result from the additional claims, the description, and drawings.

The invention with be explained in the following in more detail with the aid of two embodiments illustrated in the drawings. It is shown in:

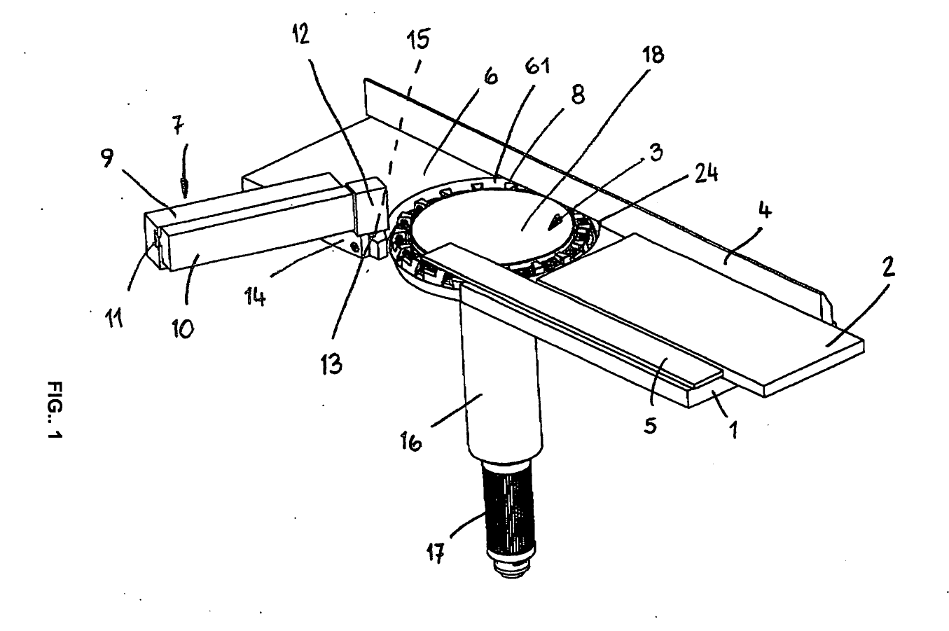

FIG. 1 in a perspective illustration a machine according to the invention for side-and-face cutting;

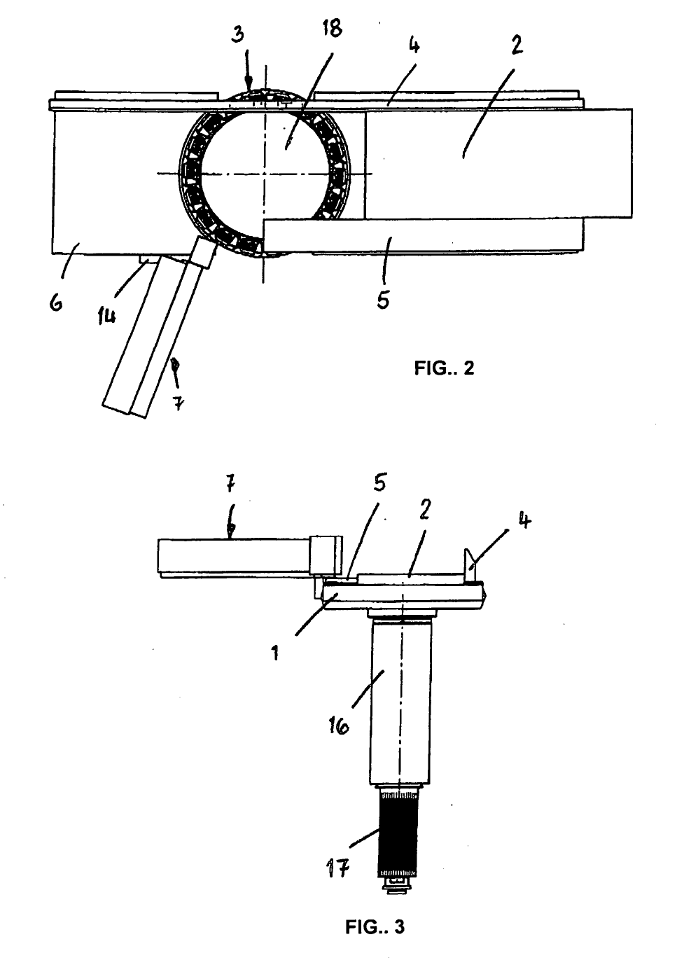

FIG. 2 a plan view onto the machine according to FIG. 1;

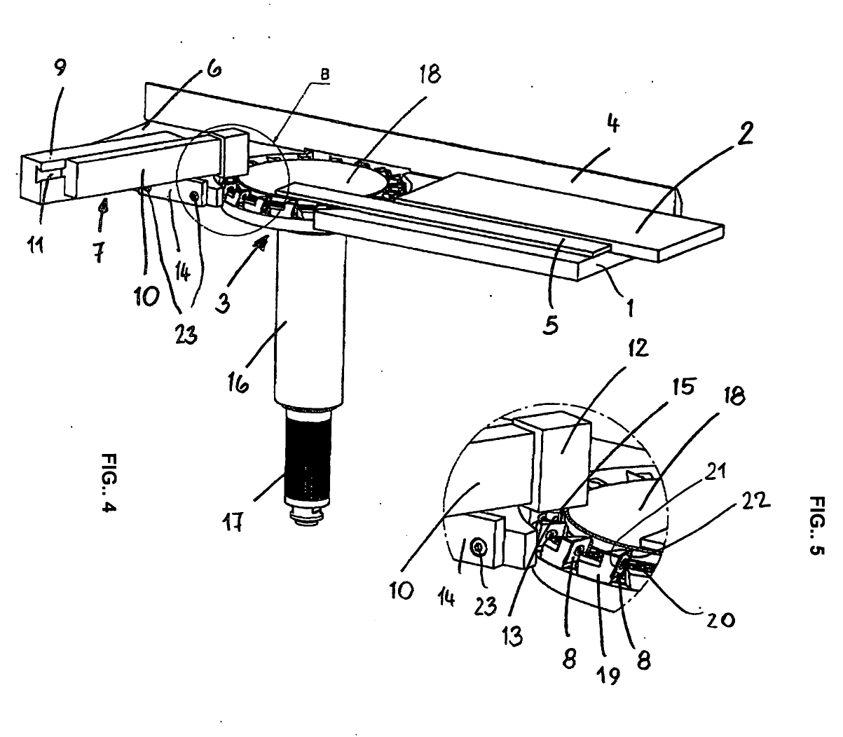

FIG. 3 an end view of the machine according to FIG. 1;

FIG. 4 in a perspective illustration the machine according to the invention with a jointing device in a position during the jointing process;

FIG. 5 the detail B of FIG. 4 in an enlarged illustration;

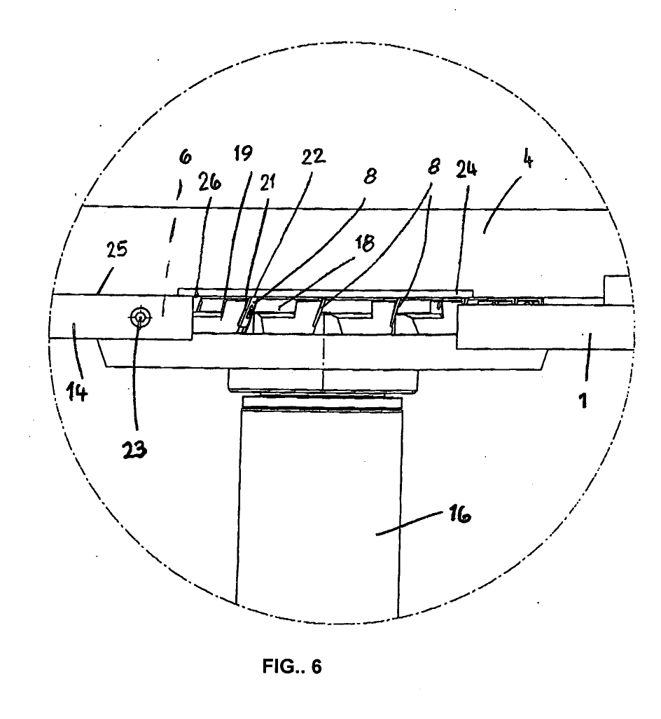

FIG. 6 in an enlarged illustration and in a front view the tool according to the invention mounted on the machine;

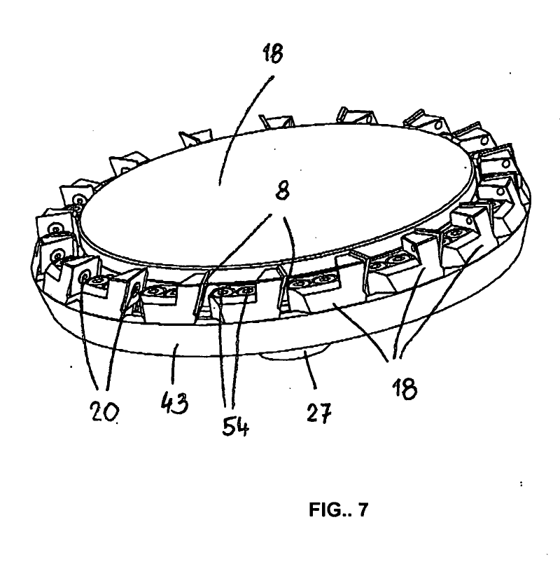

FIG. 7 in a perspective illustration the tool of the machine according to the invention;

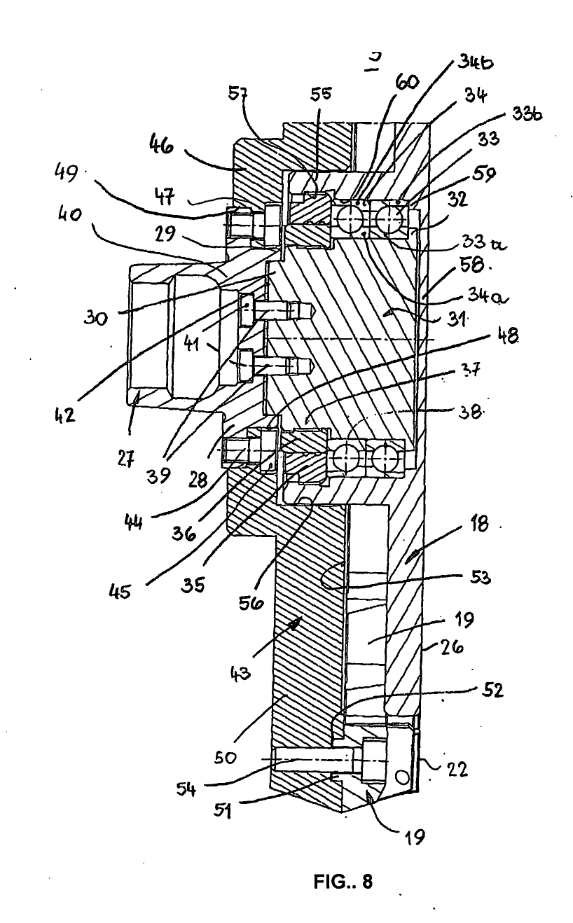

FIG. 8 a section of the tool of the machine according to the invention;

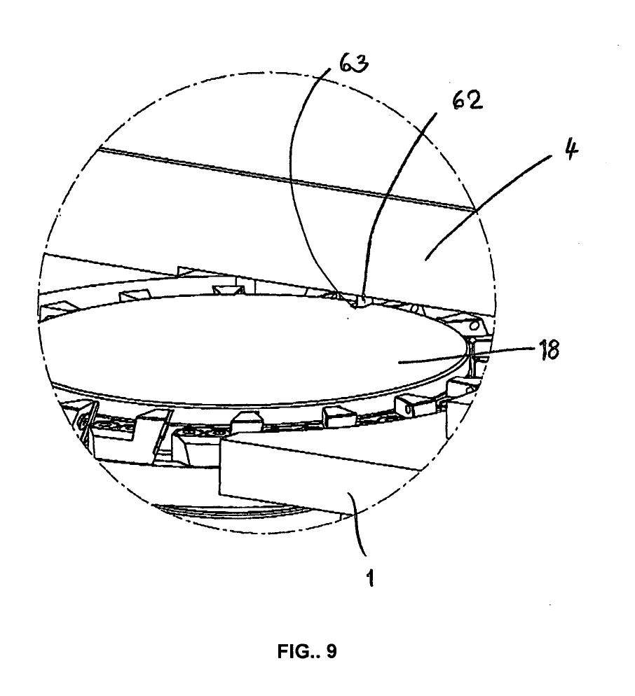

FIG. 9 in an enlarged illustration a torque support for an inner table of the tool according to the invention;

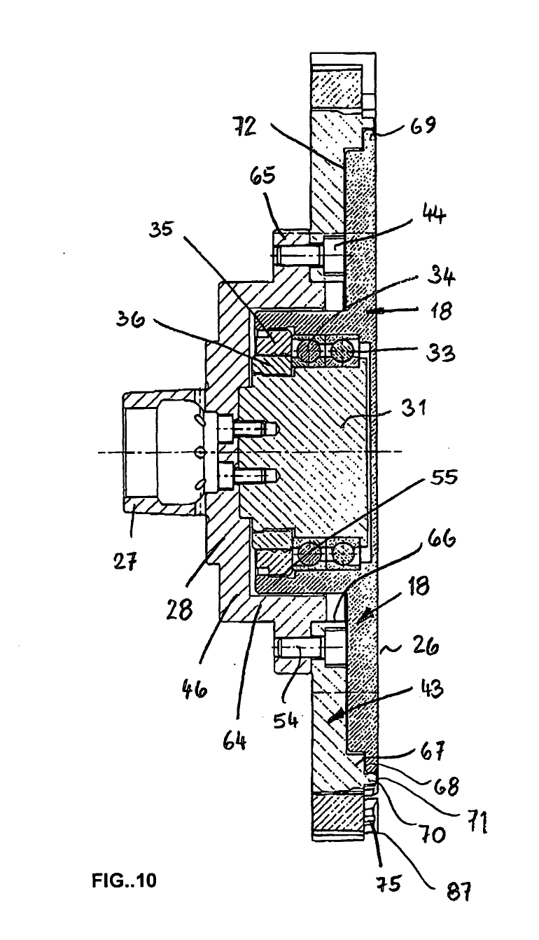

FIG. 10 in an illustration in accordance with FIG. 8 a second embodiment of a tool according to the invention;

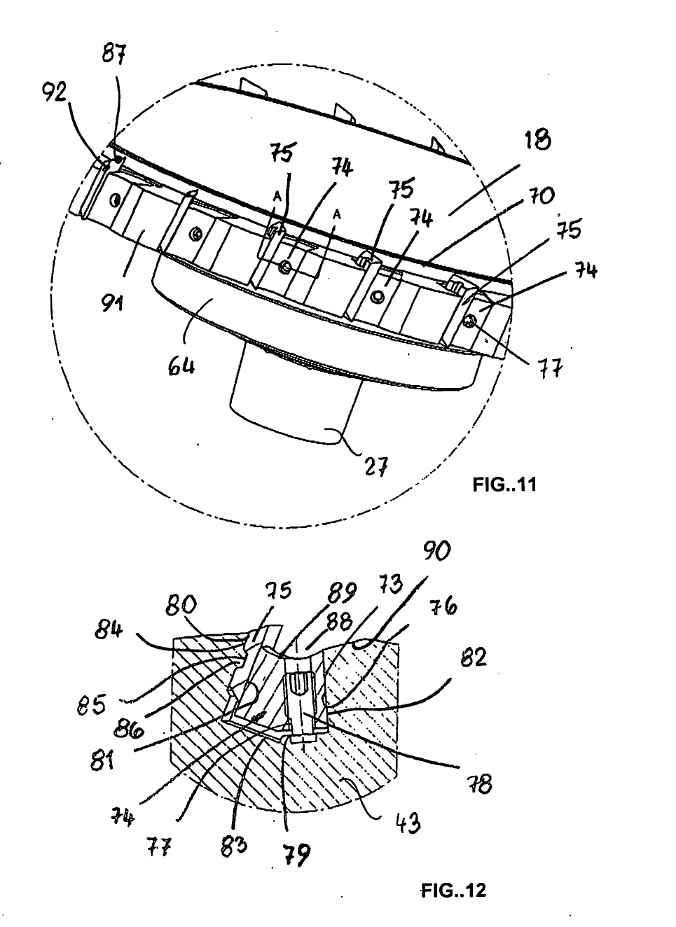

FIG. 11 in a perspective illustration a part of a tool according to FIG. 10;

FIG. 12 in an enlarged illustration a section along the line A-A of FIG. 11.

With the machine to be described in the following, workpieces, preferably comprised of wood, are machined by a side-and-face cutter. By means of side-and-face milling, groove patterns on the workpiece surface being machined are prevented.

The machine has a machine table 1 that is preferably height-adjustable in order to adjust the thickness of the chip to be removed from the workpiece 2 by the tool 3. The workpiece 2 is fed on the machine table 1 to the tool 3. When this is done, the workpiece is guided on its two longitudinal slides by the stop 4 and a linear guide in the feeding direction. The workpiece 2 is resting with its right longitudinal side, viewed in the feeding direction, against the stop 4 and with its left longitudinal side, viewed in the feeding direction, against the linear guide 5. For adjustment to different widths of the workpieces 2, the linear guide 5 is adjustable transversely to the feeding direction in a manner known in the art. The linear guide 5 extends into the area above the tool 3. The stop 4 extends across the entire feeding path of the workpiece 2. In the area of the tool 3 the machine table 1 is provided with a cutout 61 and the stop 4 with a rectangular cutout 24 at the lower edge.

On the table part 6 that, in the feeding direction of the tool 2, is behind the tool 3, a jointing device 7 is provided with which the cutting edges of the knives 8 of the tool 3 can be jointed. The jointing device 7 has a support 9 along which a joint stone carriage 10 is movable. The guiding action of the carriage 10 can be realized, for example, by means of a dovetail guide 11. The carriage 10 supports at the end that is facing the tool 3 an advancing device 12 provided with a joint stone 13. The support 9 is attached by means of a bracket 14 to the table part 6. The jointing device 7 is shown in FIG. 1 in its rest position in which the joint stone 13 secured in a holder 15 is located in an area outside of the tool knives 8.

The tool 3 is a side-and-face cutter and is received on a spindle 16, preferably a HSK spindle. The lower end of the spindle 16 is provided with a pulley 17 for providing a rotational driving action for the spindle. On the tool 3 an inner table 18 is fastened that has a top surface 26 (FIG. 6) that is positioned in the same plane as the top side 25 of the table part 6. The inner table 18 is surrounded by a ring of knife carriers 19 on which the knives 8 are attached. They are advantageously reversible knives that are secured by means of screws 20 to the front side of the knife carriers 19 in a detachable way. The knives 8 each have a main cutting edge 21 that is positioned at an angle, in the embodiment perpendicularly, to the minor cutting edge 22. By means of the joint stone 13 the minor cutting edge 22 of the knife 8 is jointed. The main cutting edges 21 of the tool 3 carry out the main material removal in a vertical cutting plane. The minor cutting edges 22 or the edge between the main and minor cutting edges 21, 22 are responsible for the quality of the surface of the workpiece 2. By means of the jointing device 7 it is ensured that the minor cutting edges 22 of the tool 3 in the plane of the table produce a uniform cutting plane so that a significant quality increase can be achieved. In this way, on the surface of the machined workpiece 2 quality-reducing grooves are reliably prevented.

The bracket 14 of the jointing device 7 is attached by means of two screws 23 (FIG. 4) on the left longitudinal side of the table part 6 in the feeding direction of the workpiece 2. By means of the dovetail guide 11 the jointing stone carriage 10 can be simply moved for jointing out of the rest position illustrated in FIG. 1 into a position above the cutting edges. FIG. 4 shows the position during the jointing process. For the jointing process, the spindle 16 is driven in rotation so that the minor cutting edges 22 of the knives 8 upon movement of the joint stone carriage 10 across the length of the carrier 9 are jointed by means of the joint stone 13.

The working diameter of the tool 3 is greater than the greatest width of the workpiece 2 to be machined. The stop 4 extends, as shown in FIG. 1 and FIG. 2, to the edge of the inner table 18, when viewed in a plan view. As especially shown in FIG. 6, the top side 25 of the table part 6 is located in a plane that contains the minor cutting edges 22. The top side 26 of the inner table 18 is also positioned in this plane that is parallel to the top side of the part of the machine table 1 that, in the feeding direction of the workpiece 2, is in front of the tool 3.

The tool 3 (FIG. 7) has a shaft 27 that is preferably a shaft with hollow shaft taper (HSK) with face contact. It has a radial outwardly oriented flange 28 that is provided on a face facing away from the shaft 27 at a minimal spacing relative to its outer edge with an annular projection 29 that serves for radial centering. It is positioned coaxially to the shaft 27. The projection 29 is engaged by an axial projection 30 of a bearing bolt 31. With this projection 30 the bearing bolt 31 rests against the inner wall of the annular projection 29 of the shaft 27 so that a proper radial centering action is achieved. The bearing bolt 31 has at its free end a narrow radially outwardly extending annular flange 32. It serves as an axial securing means for a first roller bearing 33 against which a further roller bearing 34 rests; be means of the roller bearings, the inner table 18 is rotatably supported on the bearing bolt 31. Both roller bearings 33, 34 are advantageously ball bearings and are forced by means of their inner rings 33a, 34a by a nut 36 against the annular flange 32 of the bearing bolt 31. The nut 36 is screwed onto a section 37 of the bearing bolt 31 with reduced diameter. The roller bearing 34 projects axially slightly past the section 38 of the bearing bolt 31 that has a greater outer diameter so that the two roller bearings 33, 34 can be safely axially secured.

The bearing bolt 31 itself is screwed by screws 39 to a bottom 40 of the shaft 27. The screw heads 21 are recessed in the bottom 40 of the shaft 27. Between the bottom 40 and the projection 30 of the bearing bolt 31 there is a spacer disk or adjusting disk 42 with which the top side 26 of the inner table 18 can be exactly adjusted to the height or level of the minor cutting edges 22 of the knives 8 of the tool 3.

On the flange 28 of the shaft 27 a tool body 43 is attached by screws 44 that are distributed about the circumference of the flange 28. The heads 45 are recessed within the tool body 43. It has a radially inwardly projecting flange 46 for receiving the screws 44 which flange rests with a radially inwardly projecting narrow centering ring 47 on the cylindrical outer wall 48 of the annular projection 29 of the shaft 27.

The tool body 43 has an annular support part 50 that is positioned axially displaced relative to the flange 46 and on which the knife carriers 19 are fastened. As shown in FIG. 8, the knife carriers 19 have a projection 51 that engages a matching annular groove-shaped recess 52 in the top side 53 of the support part 50. In this way, the knife carriers 19 are radially positioned on the outer edge of the support part 50. The knife carriers 19 are secured on the tool body by means of at least one screw 54 projecting through the projection 51 and screwed into the support part 50 of the tool body 43.

The inner table 18 has a central axially projecting ring 55 that has a minimal spacing relative to the inner wall 56 of the annular support part 50. The ring 55 has at its free end on the inner side a thread 57 onto which a sleeve nut 35 is screwed. The sleeve nut surrounds with minimal play the nut 36. The inner table 18 has a central part 58 that covers the bearing bolt 31. By means of a projection 59 at the transition from the inner wall 60 of the ring 55 and the bottom side of the central part 58 the inner table 18 rests on the roller bearing 33. By means of the sleeve nut 35 the two outer rings 33b, 34b of the roller bearings 33, 34 are axially clamped against the projection 59 of the inner table 18. In the mounted position, the knife carriers 19 surround the inner table 18 at a minimal spacing.

When mounting the tool 3, the roller bearings 33, 34 are pushed first onto the bearing bolt 31. Subsequently, the nut 36 is screwed onto the bolt section 37 and in this way the two roller bearings 33, 34 are clamped between the nut 36 and the annular flange 32 of the bearing bolt 31. Subsequently, the inner table 18 with its ring 55 is pushed onto the roller bearings 33, 34. Subsequently, the sleeve nut 35 is screwed into the ring 55 until it comes to rest against the roller bearing 34. The tool body 43 with the knife carriers 19 is pushed onto the shaft 27 and attached by the screws 44. In this connection, the tool body 43 is centered in the described way radially relative to the shaft 27. Subsequently, the preassembled unit of inner table 18 and bearing bolt 31 is inserted into the tool body 43 and positioned on the shaft 27 wherein, by means of the bearing bolt 31 and the two roller bearings 33, 34, the radial centering of the inner table 18 relative to the tool body 43 and the shaft 27 is realized. By means of screws 39 the bearing bolt 31 and thus the preassembled unit is attached on the shaft 27. The screws 39, because the shaft 27 is hollow, are easily accessible from the exterior. By means of the shaft 27 the tool 3 is subsequently connected to the spindle 16 that is advantageously provided with a HSK receptacle. By using the HSK interface, the inner table 18 is embodied in a constructively simple way as a component of the tool 3 and supported thereon.

The inner table 18 rotates when turning on the tool 3. As soon as the workpiece 2 is fed to the rotating tool 3, the inner table 18 will stop momentarily. It is also possible to provide on the stop 4 and/or on the linear guide 5 a torque support 62 for the inner table 18 by means of which it is achieved that only the tool body 43 with the knife carriers 19 rotates and the inner table 18 is always standing still. As shown in an exemplary fashion in FIG. 9, the torque support 62 in the form of a pin is secured on the stop 4 and projects past the lower edge of the stop 4. The pin 62 engages a recess 53 at the edge of the inner table 18 so that it cannot rotate.

In the embodiment according to FIGS. 10 and 12, the shaft 27, the flange 28, and the flange 46 are formed as a unitary part. The flange is provided on the outer edge with a ring 64 that is coaxial to the shaft 27 and provided at a minimal spacing from the free end with a radially outwardly oriented flange 65. The flange 46, the ring 64, and the flange 65 together are formed as a unitary part. The ring 55 of the inner table 18 engages the ring 64 with radial play. The tool body 43 rests on the flange 65 and is substantially formed as an annular disk. It is positioned with its radial inner rim 66 on a part of the ring 64 that projects past the flange 65 and is therefore radially centered. By means of screws 44 that are distributed about the circumference, the tool body 43 is screwed onto the flange 65. The screw heads are recessed in the tool body 43. On the outer edge, the tool body 43 is provided with a ring 67 projecting in a direction opposite to the shaft 27; it has an end face 68 that is covered by a radial flange 69 of the inner table 18. A narrow ring 70 projects away from the planar end face 68 of the ring 67; it is coaxial to the shaft 27 and has such a height that its end face 71 is positioned close to the top side 28 of the inner table 18. It engages the annular recess 72 of the tool body 43 formed by the ring 67 of the tool body 43. The tool body 43 is attached by means of screws 54 that are distributed about its circumference on the flange 65 so as to rest on the flange. As in the preceding embodiment, the inner table 18 covers the bearing bolt 31, the roller bearings 33, 34, the sleeve nut 35, and the nut 36.

On the outer edge of the tool body 43 there are receiving spaces 73 positioned at a uniform spacing to one another in which a taper gib 74 as well as a knife 75 are received, respectively. The taper gibs 74 are positioned flat on a sidewall 76 of the receiving spaces 73 and have a bore 77 that extends approximately radially relative to the tool body 43 into which bore a stud screw 78 is screwed. It is supported with one end at the bottom 79 of the receiving spaces 73. The taper gibs 74 have a spacing relative to the bottom 79. The sidewall 80 of the receiving spaces 73 that is opposite the sidewall 76 is positioned at an acute angle relative to the sidewall 76. The two sidewalls 76, 80 diverge radially inwardly. The lateral surface 81 facing the sidewall 81 of the taper gibs 74 is positioned also at an acute angle relative to the opposite lateral surface 82 with which the taper gibs 74 rest against the lateral walls 76 of the receiving spaces 73.

The bottom 79 of the receiving spaces 73 is positioned at an obtuse angle relative to the adjoining bottom section 83 that extends to the sidewall 80 of the receiving space 73. The other bottom section 78 extends away from the opposite sidewall 76 of the receiving space 73. Between the lateral surface 81 of the taper gib 74 and the sidewall 80 of the receiving space 73 the knife 75 is clamped as is known in the art. In order to achieve a radial securing action of the knife 75, it is provided on the side 84 resting against the sidewall 80 with a recess 85 that is positive lockingly engaged by a matching projection 86 of the sidewall 80 of the receiving space 73. The positive locking connection between the knife 75 and the sidewall 80 can also have a different configuration. In order for the knife 75 to be adjustable in the axial direction of the tool 3, the recesses 85 and the projections 86 of the knives 75 and the sidewalls 80 of the receiving spaces 73 extend approximately in axial direction.

The knives 75 and the taper gibs 74 are first inserted into his receiving space 73 while the stud screw 70 is unscrewed. For doing so, the knives 75 are aligned such that their recesses 85 are engaged by the projections 86. Subsequently, the stud screw 78 is screwed inwardly until it is supported on the bottom 79 of the receiving spaces 73. Upon further tightening the taper gib 74 exerts a clamping force onto the knives 75 as a result of its lateral surfaces 81, 82 positioned at an acute angle relative to one another, and the knives are therefore clamped in the circumferential direction tightly against the sidewalls 80 of the receiving spaces 73.

The knives 75 are advantageously configured similar to knives of a tool for peripheral milling or a milling cutter that has only axially extending cutting edges that correspond to the main cutting edges 92 of the knives 75. In any case, the knives 75 each have minor cutting edges 87 that are positioned angularly, in the shown embodiment perpendicularly, to the main cutting edges 92 and are arranged with an axial angle relative to the tool body 43 that determines the cutting angle of the minor cutting edges 87. The knives 75 can be individually and independent from one another adjusted such to the top surface 26 of the inner table 18 that the minor cutting edges 87 of the knives 75 are positioned in the same plane as the topside 26 of the inner table 18. In this way, in this embodiment the spacer/adjusting disk 42 between the bearing bolt 31 and the bottom 40 of the shaft 27 provided in the preceding embodiment can be eliminated. The knives 75 again define a circular arrangement of knives surrounding the inner table 18.

The tool according to FIGS. 10 to 12 is characterized by a closed and compact configuration.

As shown in FIG. 12, the knives 75 project radially past the tool body 43 as well as past the taper gibs 74. In this way, in the rotational direction of the tool in front of each knife 75 a chip space 88 is formed by means of which the chips produced by machining the workpiece can be reliably removed. The chip space 88 is formed by the radial, concavely curved outer side 89 and the continuously adjoining slanted outer side 90 of the outer edge 91 (FIG. 11) of the tool body 43. The slantedly and radially inwardly extending outer section 90 adjoins at an obtuse angle the edge 91 of the tool body 43.

In other respects, the tool according to FIGS. 10 to 12 is identical to that of the preceding embodiment.

What is claimed is:

1.-25. (canceled)

26. Machine for machining workpieces of wood and plastics, the machine comprising:
a rotatably driven spindle;
at least one tool that is seated on the rotatably driven spindle and has a circular arrangement of knives;
an inner table acting as a workpiece support, wherein the circular arrangement of knives surrounds the inner table and wherein the inner table is a component of the tool;
a machine table on which the workpieces are fed to the at least one tool.

27. Machine according to claim 25, wherein the at least one tool is a side-and-face cutter.

28. Machine according to claim 25, wherein the inner table is supported in the at least one tool.

29. Machine according to claim 25, wherein the machine table has a recess in which the at least one tool is positioned.

30. Machine according to claim 25, wherein a part of the machine table positioned in front of the at least one tool in a feeding direction of the workpiece is height-adjustable.

31. Machine according to claim 25, wherein a support side of a part of the machine table positioned in the feeding direction of the workpiece behind the at least one tool and cutting edges of the at least one tool working on the workpiece are positioned in a common plane.

32. Machine according to claim 25, comprising a jointing device for cutting edges of the at least one tool.

33. Machine according to claim 32, wherein the jointing device has a carriage that is adjustable transversely to an axis of rotation of the at least one tool, wherein at least one joint stone is arranged on the carriage.

34. Tool for a machine according to claim 25, the tool comprising:
a tool body;
a circular arrangement of knives supported on the tool body;
a spindle driven in rotation wherein the tool body is seated on the spindle;
an inner table, wherein the circular arrangement of knives surrounds the inner table.

35. Tool according to claim 34, further comprising a bearing bolt on which the inner table is rotatably supported.

36. Tool according to claim 35, further comprising at least one rotary bearing supporting the inner table on the bearing bolt, wherein the inner table has a sleeve that surrounds the at least one rotary bearing.

37. Tool according to claim 36, wherein the inner table is radially centered relative to the tool body.

38. Tool according to claim 36, further comprising a shaft, wherein the tool body is fixedly connected to the shaft.

39. Tool according to claim 38, wherein the bearing bolt is fixedly connected to the shaft.

40. Tool according to claim 36, wherein the inner table covers the bearing bolt.

41. Tool according to claim 36, wherein a top side of the inner table and cutting edges working on a workpiece are positioned in a common plane.

42. Tool according to claim 36, further comprising a sleeve nut that is screwed into the sleeve.

43. Tool according to claim 42, wherein the at least one rotary bearing is axially clamped between a nut and a flange of the bearing bolt and between the sleeve nut and a projection of the inner table.

44. Tool according to claim 34, wherein the tool body has a shaft that is configured with a hollow shaft taper with face contact (HSK).

45. Tool according to claim 34, wherein the knives of the circular arrangement of knives are reversible.

46. Tool according to claim 34, further comprising a shaft comprising a ring provided with a radially outwardly projecting flange.

47. Tool according to claim 46, wherein the tool body is attached to the radially outwardly projecting flange of the ring.

48. Tool according to claim 34, wherein the circular arrangement of knives comprises axially adjustable knives.

49. Tool according to claim 48, wherein the tool body has circumferentially disposed receiving spaces and wherein the knives are clamped with taper gibs in the receiving spaces, respectively.

50. Tool according to claim 48, wherein the knives each are secured in the receiving spaces in a radial direction of the tool body by at least one positive locking connection.

51. Tool according to claim 34, wherein the inner table is secured against rotation about its axis by at least one torque support engaging the inner table.
